(19) United States
(12) Patent Application Publication
(10) Pub. No.: US 2009/0196896 A1
(43) Pub. Date: Aug. 6, 2009

(54) ANTIMICROBIAL AGENT TO INHIBIT GROWTH OF MICROORGANISMS ON DISPOSABLE PRODUCTS

(76) Inventors: David L. Patton, Webster, NY (US); Syamal K. Ghosh, Rochester, NY (US); Joseph A. Manico, Rochester, NY (US); John R. Fredlund, Rochester, NY (US); Lori L. Rayburn-Zammiello, Rochester, NY (US); Brian P. Aylward, Rochester, NY (US); Mark S. Fornalik, Rochester, NY (US); John E. Frenett, Spencerport, NY (US)

Correspondence Address: Raymond L. Owens;Patent Legal Staff, Eastman Kodak Company, 343 State Street, Rochester, NY, 14650-2201, US

(21) Appl. No.: 12/422,443

(22) Filed: Apr. 13, 2009

Related U.S. Application Data
(62) Division of application No. 11/322,854, filed on Dec. 30, 2005.

(51) Int. Cl. A01N 25/34; A01N 25/08; A01N 59/16; A01P 1/00

(52) U.S. Cl. 424/404; 424/405; 424/618; 424/411

(57) ABSTRACT

The present disclosure relates to an article having a fiber including an antimicrobial agent to inhibit growth of microorganisms. The article inhibits the growths of microorganisms in biological, physiological fluids, and non-biological solutions. The article includes a fibrous structure and silver halide particles applied to the fibers to inhibit the growth of the microorganism.

### CROSS REFERENCE TO RELATED APPLICATIONS

This application is related to the following co-pending and commonly-assigned patent applications, which are incorporated herein by reference in their respective entirety:

U.S. Ser. No. ______ filed concurrently herewith by David L. Patton, John R. Fredlund, Syamal K. Ghosh, Joseph A. Manico, Mark S. Fornalik, Lori L. Raybum-Zammiello, Brian P. Aylward, and John E. Frenett, entitled ANTIMICROBIAL AGENT TO INHIBIT THE GROWTH OF MICROORGANISM ON CLOTHING (docket 91,986).

U.S. Ser. No. ______ filed concurrently herewith by David L. Patton, Syamal K. Ghosh, Joseph A. Manico, John R. Fredlund, Brian P. Aylward, Mark S. Fomalik, John E. Frenett and Lori L. Rayburn-Zammiello, entitled ANTIMICROBIAL AGENT TO INHIBIT THE GROWTH OF MICROORGANISMS ON OUTERWEAR USED IN THE MEDICAL PROFESSION (docket 91,987).

U.S. Ser. No. ______ filed concurrently herewith by Joseph A. Manico, David L. Patton, John R. Fredlund, Syamal K. Ghosh, Lori L. Raybum-Zammiello, Mark S. Fornalik, Brian P. Aylward, and John E. Frenett, entitled ANTIMICROBIAL AGENT TO INHIBIT THE GROWTH OF MICROORGANISM ON BUILDING MATERIALS (docket 91,988).

### FIELD OF THE INVENTION

The present invention relates to an article having a fiber with an antimicrobial agent to inhibit growth of microorganisms. More particularly, a fiber with an antimicrobial composition of specific silver salts and polymeric binders attached. The composition can be used to provide antimicrobial activity to the article for inhibiting the growth of microorganisms in biological and physiological fluids, and non-biological solutions.

### BACKGROUND OF THE INVENTION

In recent years people have become very concerned about exposure to the hazards of microbe contamination. For example, exposure to certain strains of Escherichia coli through the ingestion of under-cooked beef can have fatal consequences. Exposure to Salmonella enteritidis through contact with unwashed poultry can cause severe nausea. Mold (Aspergillis niger) and yeast (Candida albicans) can cause respiratory problems and skin infections. There is, in addition, increasing concern over pathogens, such as Salmonella and E. coli:O: 157, present in medical environments and concern over viruses such as Influenza, SARS, AIDS, and hepatitis. Indeed, some forms of bacteria, including Staphylococcus aureus are resistant to all but a few or one known antibiotic.

Noble metal-ions such as silver ions are known for their antimicrobial properties and have been used in medical care for many years to prevent and treat infection. In recent years, this technology has been applied to consumer products to prevent the transmission of infectious disease and to kill harmful bacteria such as Staphylococcus aureus and Salmonella. In common practice, noble metals, metal-ions, metal salts or compounds containing metal-ions having antimicrobial properties, and other antimicrobial materials such as chlorophenyl compounds (Triclosan™), isothiazolone (Kathon™), antibiotics, and some polymeric materials, can be applied to surfaces to impart an antimicrobial property to the surface. If, or when, the surface is inoculated with harmful microbes, the antimicrobial metal-ions or metal complexes, if present in effective form and concentration, will slow or even prevent altogether the growth of those microbes. In addition, such compounds can be formed into, or coated upon, articles such as bandages, wound dressings, casts, personal hygiene items, etc.

In order for an antimicrobial article to be effective against harmful microorganisms, the antimicrobial compound must come in direct contact with microorganisms present in the surrounding environment, such as food, liquid nutrient, biological fluid, water or any solution containing microbes. Since physiological fluids are often extraordinarily complex, the treatment of a multitude of microbial contaminants can be difficult, if not impossible, with one antimicrobial compound. Further, the antimicrobial ions or compounds can be precipitated or complexed by components of the biological or physiological fluids and rendered ineffective. Microorganisms can develop resistance to organic compounds such as triclosan. Still further, microorganisms such as bacteria can develop resistance to antibiotics, biocides and antimicrobials, and more dangerous microbes can result.

The antimicrobial properties of silver have been known for several thousand years. The general pharmacological properties of silver are summarized in “Heavy Metals”—by Stewart C. Harvey and “Antiseptics and Disinfectants: Fungicides; Ectoparasiticides”—by Stewart Harvey in The Pharmacological Basis of Theraeutics, Fifth Edition, by Louis S. Goodman and Alfred Gilman (editors), published by MacMillan Publishing Company, NY, 1975. It is now understood that the affinity of silver ion to biologically important moieties such as sulfhydryl, amino, imidazole, carboxyl and phosphate groups are primarily responsible for its antimicrobial activity.

The attachment of silver ions to one of these reactive groups on a protein results in the precipitation and denaturation of the protein. The extent of the reaction is related to the concentration of silver ions. The diffusion of silver ion into mammalian tissues is self-regulated by its intrinsic preference for binding to proteins through the various biologically important moieties on the proteins, as well as precipitation by the chloride ions in the environment. Thus, the very affinity of silver ion to a large number of biologically important chemical moieties (an affinity which is responsible for its action as a germicidal/biocidal/viricidal/fungicidal/bacterioridal agent) is also responsible for limiting its systemic action—silver is not easily absorbed by the body. This is a primary reason for the tremendous interest in the use of silver containing species as an antimicrobial, i.e., an agent capable of destroying or inhibiting the growth of microorganisms, such as bacteria, yeast, fingi and algae, as well as viruses.

In addition to the affinity of silver ions to biologically relevant species that leads to the denaturation and precipitation of proteins, some silver compounds, those having low ionization or dissolution ability, also function effectively as antiseptics. Distilled water in contact with metallic silver becomes antibacterial even though the dissolved concentration of silver ions is less than 100 ppb. There are numerous mechanistic pathways by which this oligodynamic effect is manifested, i.e., ways in which silver ion interferes with the basic metabolic activities of bacteria at the cellular level to provide a bactericidal and/or bacteriostatic effect.

A detailed review of the oligodynamic effect of silver can be found in “Oligodynamic Metals” by I. B. Romans in Disinfection, Sterilization and Preservation, C. A. Lawrence and S. S. Bloek (editors), published by Lea and Fibiger (1968) and “The Oligodynamic Effect of Silver” by A. Goetz, R. L. Tracy and F. S. Harris, Jr. in Silver in Industry, Lawrence Addicks (editor), published by Reinhold Publishing Corporation, 1940. These reviews describe results that demonstrate that silver is effective as an antimicrobial agent towards a wide range of bacteria, and that silver can impact a cell through multiple biochemical pathways, making it difficult for a cell to develop resistance to silver. However, it is also known that the efficacy of silver as an antimicrobial agent depends critically on the chemical and physical identity of the silver source. The silver source can be silver in the form of metal particles of varying sizes, silver as a sparingly soluble material such as silver chloride, silver as a highly soluble salt such as silver nitrate, etc. The efficiency of the silver also depends on i) the molecular identity of the active species—whether it is Ag⁺ ion or a complex species such as (AgCl₂)⁻, etc., and ii) the mechanism by which the active silver species interacts with the organism, which depends on the type of organism. Mechanisms can include, for example, adsorption to the cell wall which causes tearing; plasmolysis where the silver species penetrates the plasma membrane and binds to it; adsorption followed by the coagulation of the protoplasm; or precipitation of the protoplasmic albumin of the bacterial cell. The antibacterial efficacy of silver is determined, among other factors, by the nature and concentration of the active species, the type of bacteria; the surface area of the bacteria that is available to interaction with the active species, the bacterial concentration, the concentration and/or the surface area of species that could consume the active species and lower its activity, and the mechanisms of deactivation.

It is clear from the literature on the use of silver based materials as antibacterial agents that there is no general procedure for precipitating silver based materials and/or creating formulations of silver based materials that would be suitable for all applications. Since the efficacy of the formulations depends on so many factors, there is a need for i) a systematic process for generating the source of the desired silver species, ii) a systematic process for creating formulations of silver based materials with a defined concentration of the active species; and iii) a systematic process for delivering these formulations for achieving predetermined efficacy. There is particularly a need for processes that are simple and cost effective.

One very important use of silver based antimicrobials is for textiles Various methods are known in the art to render antimicrobial properties to a target fiber. The approach of embedding inorganic antimicrobial agents, such as zeolites, into low melting components of a conjugated fiber is described in U.S. Pat. No. 4,525,410 and U.S. Pat. No. 5,064,599. In another approach, the antimicrobial agent can be delivered during the process of making a synthetic fiber such as those described in U.S. Pat. No. 5,180,402, U.S. Pat. No. 5,880,044, and U.S. Pat. No. 5,888,526, or via a melt extrusion process as described in U.S. Pat. No. 6,479,144 and U.S. Pat. No. 6,585,843. In still yet another process, an antimicrobial metal ion can be ion exchanged with an ion exchange fiber as described in U.S. Pat. No. 5,496,860.

Methods of transferring an antimicrobial agent, in the form of an inorganic metal salt or zeolite, from one substrate to a fabric are disclosed in U.S. Pat. No. 6,461,386. High-pressure laminates containing antimicrobial inorganic metal compounds are disclosed in U.S. Pat. No. 6,248,342. Deposition of antimicrobial metals or metal-containing compounds onto a resin film or target fiber has also been described in U.S. Pat. No. 6,274,519 and U.S. Pat. No. 6,436,420.

It is also known in the art that fibers can be rendered with antimicrobial properties by applying a coating of silver particles. Silver ion-exchange compounds, silver zeolites and silver glasses are all known to be applied to fibers through topical applications for the purpose of providing antimicrobial properties to the fiber as described in U.S. Pat. No. 6,499,320, U.S. Pat. No. 6,584,668, U.S. Pat. No. 6,640,371 and U.S. Pat. No. 6,641,829. Other inorganic antimicrobial agents can be contained in a coating that is applied to a fiber as described in U.S. Pat. No. 5,709,870, U.S. Pat. No. 6,296,863, U.S. Pat. No. 6,585,767 and U.S. Pat. No. 6,602,811.

It is known in the art to use binders to apply coating compositions to impart antimicrobial properties to various substrates. U.S. Pat. No. 6,716,895 describes the use of hydrophilic and hydrophobic polymers and a mixture of oligodynamic metal salts as an antimicrobial composition, in which the water content in the coating composition is preferably less than 50%. The mixture of oligodynamic metal salts are intended to span a wide range of solubilities and would not be useful in a durable coating application. U.S. Pat. No. 5,709,870 describes the use of carboxymethyl cellulose-silver complexes to provide an antimicrobial coating to a fiber. The use of silver halides in an antimicrobial coating, particularly for medical devices, is described in U.S. Pat. No. 5,848,995.

In particular, the prior art has disclosed formulations that are useful for highly soluble silver salts having solubility products, herein referred to as pKsp, of less than 1. Generally, these silver salts require the use of hydrophobic addenda to provide the desired combinations of antimicrobial behavior and durability. Conversely, it is also know that very insoluble metallic silver particles, having a pKsp greater than 15, would require hydrophilic addenda to provide the desired combinations of antimicrobial behavior and durability.

It is also well known in the photographic art that gelatin is a useful hydrophilic polymer in the production of photographic silver halide emulsions. Gelatin is present during the precipitation of, for example, silver chloride from its precursor salts. For most practical photographic coating formulations, the amount of gelatin is above 3% during the precipitation stages and preferably above 10% during the coating applications for film or paper products. It is a desirable feature that the gelatin is present in an amount sufficient to solidify or gel the composition. This is desired to minimize settling of the dense silver halide particles. The high gelatin levels are themselves a source of bioactivity and it is common practice to add biostats or biocides to minimize or prevent spoilage of the photographic emulsion prior to the coating application.

### SUMMARY OF THE INVENTION

In general terms, the present disclosure relates to inhibiting the growth of microorganisms by applying silver halide particles to the fibers of an article.

In one embodiment, an article having an antimicrobial agent to inhibit the growth of microorganisms in biological, non-biological and physiological fluids is provided. The article includes a structure having fibers and silver halide particles bound to the fibers using a hybrophilic gelatin polymer composition that does not substantially solidity or gel.

In another embodiment, a method for creating an article having an antimicrobial agent to inhibit the growth of microorganisms in biological, non-biological and physiological fluids is provided. The method includes providing a structure having fibers and binding silver halide particles to the fibers using a hydrophilic gelatin polymer composition that does not substantially solidity or gel.

In yet another embodiment, a method for creating an article having an antimicrobial agent to inhibit the growth of microorganisms in biological, non-biological and physiological fluids is provided. The method includes providing a structure having fibers, binding silver halide particles to the fibers using a hydrophilic gelatin polymer composition which does not substantially solidify or gel, and applying a hydrophobic binder resin to the fibers.

### BRIEF DESCRIPTION OF THE DRAWINGS

FIG. 1 is a photograph showing untreated fibers;

FIGS. 2A and 2B are photographs showing fibers treated with silver halide particles in accordance with the present invention;

FIG. 3 illustrates a plan view of a bandage made in accordance with the present invention applied to the arm of an individual;

FIG. 4 is an enlarged partial cross sectional view of a portion of the bandage of FIG. 3 as taken along line 4-4;

FIG. 5 is a greatly enlarged partial cross sectional view of a portion of the bandage of FIG. 4 identified by circle 5;

FIG. 6 is a perspective view of a tampon made in accordance with the present invention partially broken away to illustrate an inner core;

FIG. 7A is an enlarged partial cross sectional view of a portion of the tampon of FIG. 6 as taken along line 7-7;

FIG. 7B is an enlarged partial view of the fibrous portion of FIG. 7A as represented by the circle 7B;

FIG. 8 is a perspective view of a sanitary napkin for use by woman also made in accordance with the present invention;

FIG. 9 is an enlarged partial cross sectional view of a portion of the sanitary napkin of FIG. 8 as taken along line 9-9;

FIG. 10 illustrates an exploded perspective view of a disposable diaper made in accordance with the present invention; and

FIG. 11 is an enlarged partial cross sectional view of a portion of the diaper of FIG. 10 as taken along line 11-11.

### DETAILED DESCRIPTION OF THE INVENTION

Various embodiments will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

This invention can be applied to material composed of fibers to provide antibacterial and/or anti-fungal protection to the material in a variety of end-use applications. Topical application of this material is accomplished through traditional padding technology (dip coating), followed by a short, high-temperature curing step to permanently link the antimicrobial material to the fibers in the material. Typical end-use applications include active wear (apparel worn during a sport or physical activity, such as running or cycling shirts, gym suits, golf and tennis wear, etc); athletic wear (apparel worn for sporting events, such as team jerseys, socks, athletic shorts, etc.); undergarments (apparel worn in direct contact with the skin, such as undershirts, underwear, bras, etc.); uniforms (apparel typically worn by organizations such as schools, hospitals, and manufacturing workers garments, where a garment is exposed to aggressive and harsh cleaning treatments to allow the garment to be worn by more than one person); and home furnishings (such as bed linens, bath towels, pillow cases, sheets, hospital bed coverings, shower curtains, table cloths, napkins, hand towels, etc.).

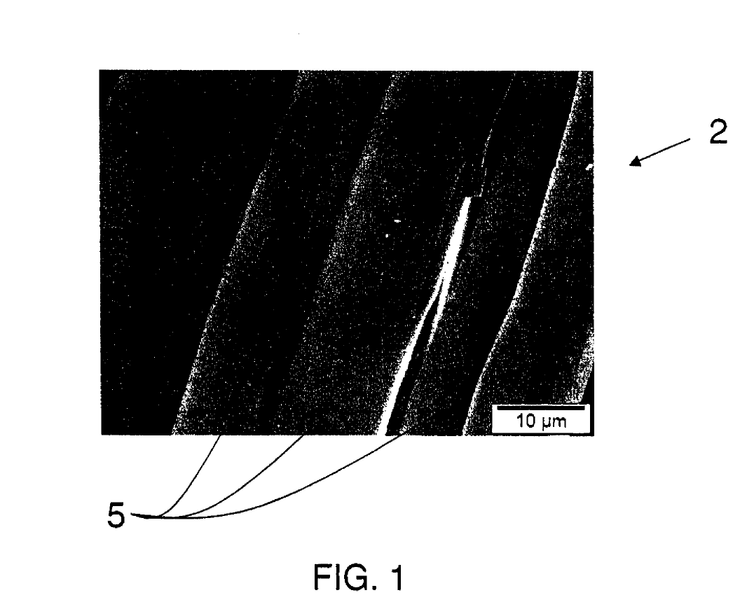

FIG. 1 is a photograph illustrating typical fibers that have not been treated with antimicrobial agents, generally shown as 2. In one embodiment of FIG. 1, numerous fibers 5 can form an article. The fibers 5 have not been treated with an antimicrobial agent, such as silver halide particles.

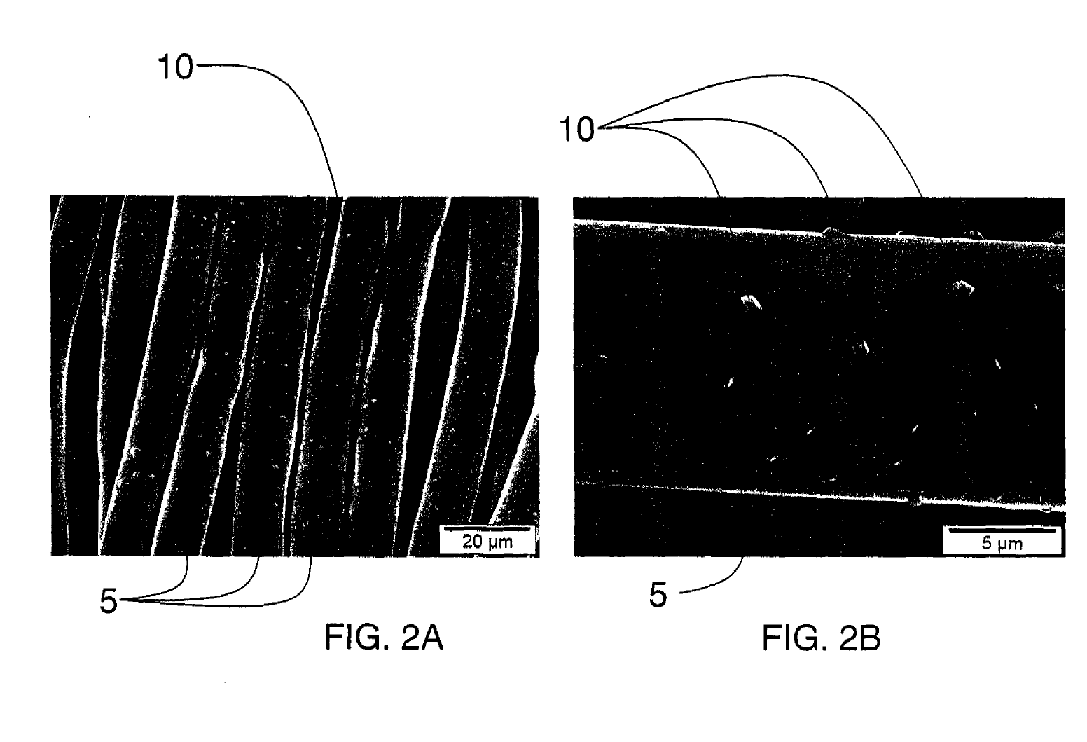

FIG. 2A is a photograph showing fibers 5 which have been treated using a process that applies silver halide particles 10 and a hydrophilic polymer (not shown) in accordance with one embodiment. Similarly, FIG. 2B is a photograph showing a single fiber 5 with the silver halide particles 10 attached.

The articles of the embodiment can include, but are not limited to, disposable health care items such as gauze, band aids, bandages, cotton swabs and cotton balls, disposable personal care items such as diapers, tampons, feminine napkins, panty liners, shoe liners, facial tissues, toilet paper and the like. The articles are useful for preventing microbial growth in biological and physiological fluids. The articles can provide for the health and safety of the general public. The articles can also provide for the health and safety of animals. These articles can be placed against, within or in close proximity to the body of a human or animal. The articles further contain an effective amount of an antimicrobial agent, which quickly reduces the population of microbes to a manageable level.

The term inhibition of microbial-growth, or a material which “inhibits” microbial growth, is used by the authors to mean materials that prevent microbial growth, subsequently kills microbes so that the population is within acceptable limits, significantly retard the growth processes of microbes or maintain the level or microbes to a prescribed level or range. The prescribed level can vary widely depending upon the microbe and its pathogenicity; generally it is preferred that harmful organisms are present at no more than 10 organisms/ml and preferably less than 1 organism/ml.

Antimicrobial agents which kill microbes or substantially reduce the population of microbes are often referred to as biocidal agents, while materials which simply slow or retard normal biological growth are referred to as biostatic agents. The preferred impact upon the microbial population can vary widely depending upon the application. For example, in pathogenic organisms (such as Group A streptococcal) a biocidal effect is preferred, while for less harmful organisms a biostatic impact is preferred. Generally, it is preferred that microbiological organisms remain at a level, which is not harmful to the consumer or user of that particular article, or to the function of the treated article.

In one embodiment, an antimicrobial agent composition includes at least 50% water, silver halide particles 10, and a hydrophilic polymer, i.e., hydrophilic binder. The hydrophilic polymer is of a type and used in an amount in which the composition does not substantially gel or solidify at 25 degrees C. In practical terms, the composition, when sold as a concentrate, must be able to flow at 25 degrees C. and be easily mixed with an aqueous diluent or other addenda prior to use as an antimicrobial coating for yarn or textile. The composition also encompasses a more diluted form that is suitable for dip, pad, spray or other types of coating.

The composition is substantially free of organic solvents. Preferably, no organic solvent is intentionally added to the composition. The composition must exhibit antimicrobial activity upon drying. In its concentrated form, the composition must include at least 50% water by weight. In another embodiment, the composition includes at least 70% water by weight. In its diluted form, the composition consists of greater than 95% water.

The silver halide particles 10 can be of any shape and halide composition. The type of halide can include chloride, bromide, iodide and mixtures of them. The silver halide particles 10 can include, for example, silver bromide, silver iodobromide, bromoiodide, silver iodide or silver chloride. However, the embodiment is not limited to these compositions, and any suitable composition can be used. In one embodiment, the silver halide particles 10 are predominantly silver chloride. The predominantly silver chloride particles 10 can include, hut is not limited to, silver chloride, silver bromochloride, silver iodochloride, silver bromoiodochloride and silver iodobromochloride particles. By predominantly silver chloride, it is meant that the particles are greater than about 50 mole percent silver chloride. Preferably, they are greater than about 90 mole percent silver chloride, and optimally greater than about 95 mole percent silver chloride. The silver halide particles 10 can either be homogeneous in composition or the core region can have a different composition than the shell region of the particles. The shape of the silver halide particles can be cubic, octahedral, tabular or irregular. More silver halide properties can be found in “The Theory of the Photographic Process”, T. H. James, ed., 4th Edition, Macmillan (1977). In another embodiment the silver halide particles have a mean equivalent circular diameter of less than 1 micron, and preferably less 0.5 microns.

The silver halide particles 10 and associated coating composition of the present embodiment are applied to the fiber 5 or fabric in an amount sufficient to provide antimicrobial properties to the treated fiber for a minimum of at least 10 washes, more preferably 20 washes and most preferably after 30 washes in accordance with ISO 6330:2003 (other antimicrobial textile test methods include AATCC-100 and New York State Proposed Method 1241). The amount of silver halide particles 10 applied to the target fiber 5 or textile fabric is determined by the desired durability or length of time of antimicrobial properties. The amount of silver halide particles 10 present in the composition will depend on whether the composition is one being sold in a concentrated form suitable for dilution prior to coating or whether the composition has already been diluted for coating.

Typical levels of silver salt particles (by weight percent) in the formulation are preferably from about 0.000001% to about 10%, more preferably from about 0.0001% to about 1% and most preferably from about 0.001% to 0.5%. In a concentrated format, the composition preferably includes silver halide particles in an amount of 0.001 to 10%, more preferably 0.001 to 1%, and most preferably 0.001 to 0.5%. In a diluted format, the composition preferably includes silver halide particles in an amount from about 0.000001% to about 0.01%, more preferably from about 0.00001% to about 0.01% and most preferably from about 0.0001% to 0.01%. It is a desirable feature of the embodiment to provide efficient antimicrobial properties to the target fiber or textile fabric at a minimum silver halide level to minimize the cost associated with the antimicrobial treatment.

In one embodiment, the preferred hydrophilic polymers are soluble in water at concentrations greater than approximately 2%, preferably greater than approximately 5%, and more preferably greater than approximately 10%. Therefore, suitable hydrophilic polymers do not require an organic solvent to remain fluid at 25 degrees C. Suitable hydrophilic polymers useful in the embodiment include, for example, gelatin, polyacrylic acid, polyacrylamide, polyvinyl alcohol, polyvinylpyrrolidones, cellulose etc. into the reaction vessel The polymers peptize or stabilize silver halide particles help maintain colloidal stability of the solution.

In another embodiment, a preferred hydrophilic polymer is gelatin. Gelatin is an amphoteric polyelectrolyte that has excellent affinity to a number of substrates. The gelatin can be processed by any of the well-known techniques in the art including, but not limited to: alkali-treatment, acid-treatment, acetylated gelatin, phthalated gelatin or enzyme digestion. The gelatin can have a wide range of molecular weights and can include low molecular weight gelatins if it is desirable to raise the concentration of the gelatin in the inventive composition without solidifying the composition. The gelatin in the present embodiment is added in an amount sufficient to peptize the surface of the silver halide and some excess of gelatin will always be present in the water phase. The gelatin level can be chosen such that the composition does not substantially solidify or gel. In the present embodiment, the weight percentage of gelatin is less than 3%, preferably less than 2%, and more preferably less than 1%. The gelatin of the present embodiment can also be cross-linked in order to improve the durability of the coating composition containing the antimicrobial silver halide particles 10.

Silver halide particles can be formed by reacting silver nitrate with halide in aqueous solution. In the process of silver halide precipitation, one can add the hydrophilic polymers to peptize the surface of the silver halide particles thereby imparting colloidal stability to the particles, see for example, Research Disclosure September 1997, Number 401 published by Kenneth Mason Publications, Ltd., Dudley Annex, 12a North Street, Emsworth, Hampshire PO10 7DQ, ENGLAND, the contents of which are incorporated herein by reference.

In addition to the hydrophilic binder, a hydrophobic binder resin is preferably used to improve the adhesion and durability of the silver salt particles once applied to a fabric surface. Such hydrophobic binders are well known in the art and are typically provided as aqueous suspensions of polymer microparticles. Materials suitable for use as hydrophobic binders include, but are not limited to, acrylic, styrene-butadiene, polyurethane, polyester, polyvinyl acetate, polyvinyl acetal, vinyl chloride and vinylidine chloride polymers, including copolymers thereof. In one embodiment, acrylic polymers and polyurethane are preferred.

The hydrophobic binders should have film-forming properties that include a range of glass transition temperatures from about −30 C to about 90 C. The hydrophobic binder particles can have a wide range of particle sizes from about 10 nm to about 10,000 nm and can be poly-dispersed in distribution. The hydrophobic binders can also be thermally or chemically cross-linkable in order to modify the desired durability properties of the antimicrobial fiber or fabric textile. The hydrophobic binders can be nonionic or anionic in nature. Useful ranges of the hydrophobic binders are generally less than about 10% of the composition. It is understood that the choice of the hydrophobic binder can be related to specific end use requirements of the fiber or fabric textile including, wash resistance, abrasion (crock), tear resistance, light resistance, coloration, hand and the like. As described in more detail below the hydrophobic binder is generally kept separate from the hydrophilic polymer/silver halide particle composition until a short time prior to coating.

In one embodiment, a composition including silver salt particles, hydrophilic binder and optionally, hydrophobic binder or gelatin cross-linker, can be applied to the target fiber or textile fabric in any of the well know techniques in art. These techniques include, but are not limited to, pad coating, knife coating, screen coating, spraying, foaming and kiss-coating. The components of the composition are preferably delivered as a separately packaged two-part system involving colloidal silver halide particles and hydrophilic binder as one part (part A) and a second part (part B) including an aqueous suspension of a hydrophobic binder, or gelatin cross-linker, and optionally, a second hydrophilic binder that can be the same or different as the hydrophilic binder from part A. The first part, including colloidal silver halide particles and hydrophilic binder, has an excellent shelf-life without compromising colloidal stability. The two parts can be combined prior to a padding or coating operation and exhibit colloidal stability for the useful shelf-life of the composition, typically on the order of several days.

There can also be present optional components, for example, thickeners or wetting agents to aid in the application of the composition to the target fiber or textile fabric. Examples of wetting materials include surface active agents commonly used in the art such as ethyleneoxide-propyleneoxide block copolymers, polyoxyethylene alkyl phenols, polyoxyethylene alkyl ethers, and the like. Compounds useful as thickeners include, for example, particulates such as silica gels and smectite clays, polysaccharides such as xanthan gum, polymeric materials such as acrylic-acrylic acid copolymers, hydrophobically modified ethoxylated urethanes, hydrophobically modified nonionic polyols, hydroxypropyl methylcellulose and the like.

Also, an agent to prevent latent image formation is useful in the compositions. Some silver salts are light sensitive and discolor upon irradiation of light. However, the degree of light sensitivity can be minimized by several techniques known to those who are skilled in the art. For example, storage of the silver halide particles in a low pH environment will minimize discoloration. In general, pH below 7.0 is desired and more specifically, pH below 4.5 is preferred. Another technique to inhibit discoloration involves adding compounds of elements, such as, iron, iridium, rhuthinium, palladium, osmium, gallium, cobalt, rhodium, and the like, to the silver halide particles. These compounds are known in the photographic art to change the propensity of latent image formation; and thus the discoloration of the silver salt. Additional emulsion dopants are described in Research Disclosure, February 1995, Volume 370, Item 37038, Section XV.B., published by Kenneth Mason Publications, Ltd., Dudley Annex, 12a North Street, Elmsworth, Hampshire PO10 7DQ, England.

The embodiment is not limited to any particular fiber or textile fabric or yarn including, exhaustively any natural or manufactured fibers. Examples of natural fibers include, but are not limited to, cotton (cellulosic), wool, or other natural hair fibers, for example, mohair and angora. Examples of manufactured fibers include synthetics, such as, polyester, polypropylene, nylon, acrylic, polyamide, or, regenerated materials such as cellulosics and the like, or blends of materials such as polyester/cotton. The target fiber or yarn can include any number of chemistries or applications prior to, during and/or after the application of the antimicrobial composition including, for example, antistatic control agents) flame retardants, soil resistant agents, wrinkle resistant agents, shrink resistant agents, dyes and colorants, brightening agents, UV stabilizers, lubricants, antimigrants, and the like.

The articles are useful for preventing microbial growth in biological and physiological fluids, and can be used to treat or prevent infection in wounds, and to prevent infection resulting from contact with physiological fluids such as blood, urine, fecal matter, etc. In one embodiment, the article is designed to be placed against the skin of an individual. In another embodiment, the article includes a bandage. It is preferred that the bandage includes a liquid permeable barrier layer for allowing the biological or physiological fluids to come in contact with derivatized particles. In yet another embodiment, the article includes a diaper. It is preferred that the diaper includes a liquid permeable membrane for allowing biological or physiological fluids to come in contact with the derivatized particles. It is also preferred that the diaper includes a liquid permeable membrane for allowing the biological or physiological fluids to come in contact with the silver compositions as described above.

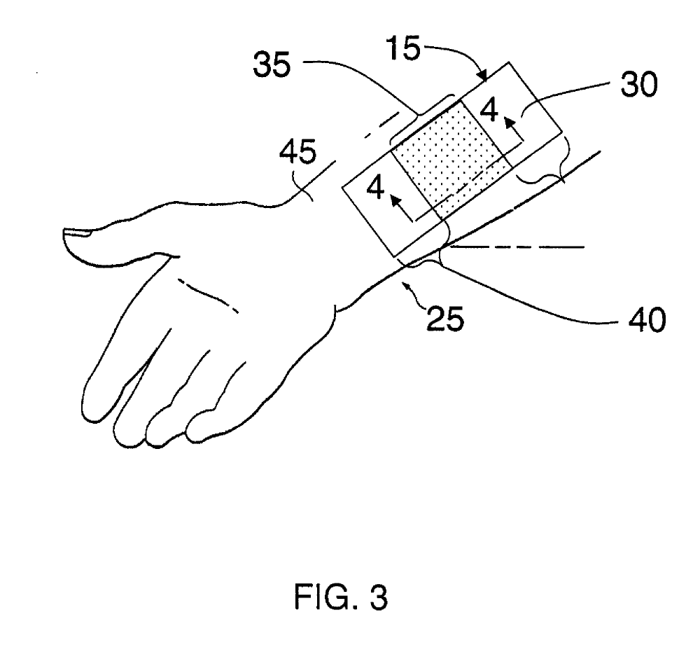

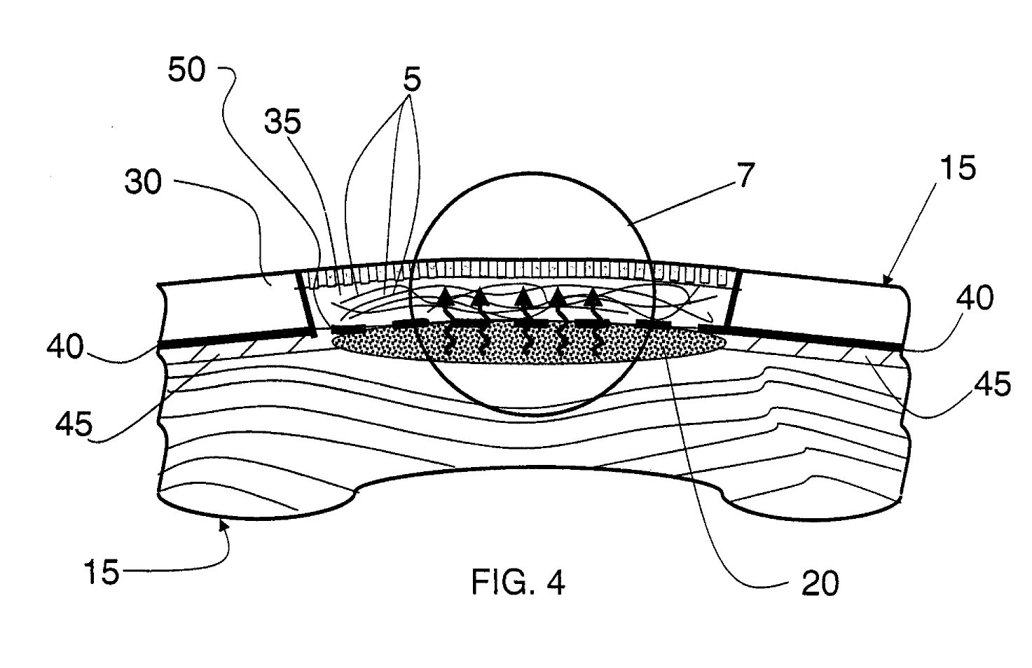

FIG. 3 illustrate a typical prior art article such as a bandage 15 placed over a wound 20 (FIG. 4) an arm 25 of an individual. In the embodiment illustrated, the bandage 15 includes a support 30 holding a pad 35 for absorbing biological and physiological fluids and the exudates of the wound. The support 30 also holds the adhesive section 40 for attaching the bandage 15 to the skin 45.

FIG. 4 illustrate a cross-sectional view 4-4 of a typical prior art article such as a bandage 15 placed over a wound 20 of an arm 25 of an individual as illustrated in FIG. 3. The pad 35 containing fibers 5 can be covered with an anti stick layer 50 to prevent the pad 35 from sticking to the wound 20.

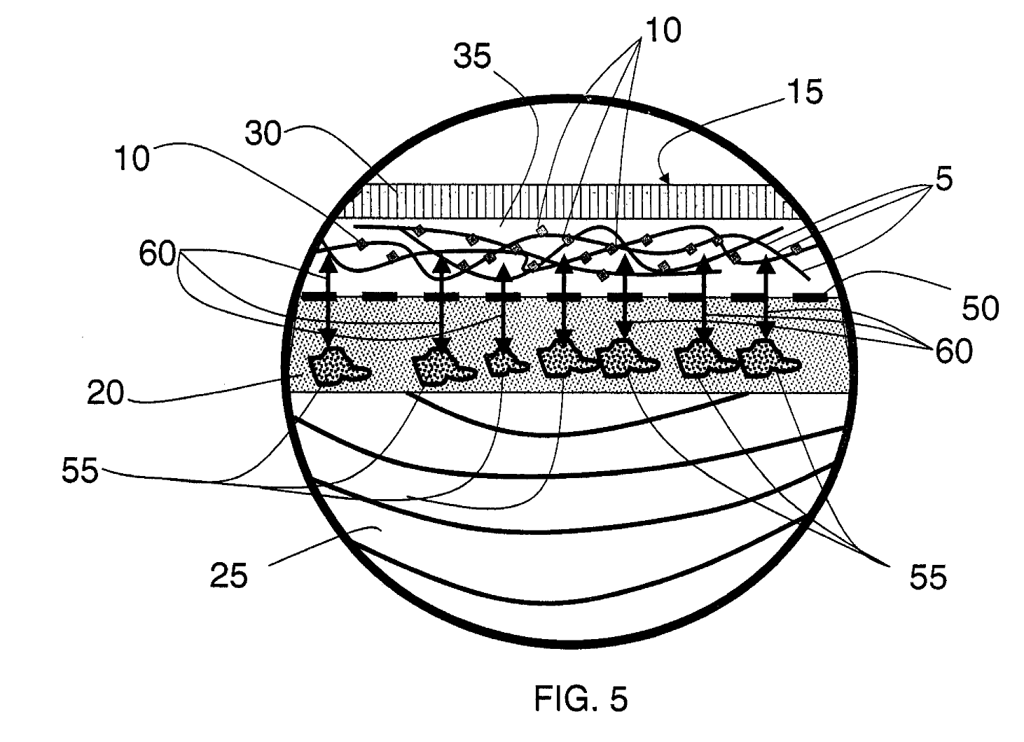

FIG. 5 illustrated an enlarged partial cross sectional view 7 of a portion of the bandage 15 as illustrated in FIG. 4. The microorganisms 55 are free to move from the wound 20 through the non-stick layer 50 of the bandage 15 and back to the wound 20 as indicated by the arrows 60. The ability of the microorganisms 55 to freely transfer back and forth allows the wound to be reinfected. In one embodiment, fibers 5 in the pad 35 of the bandage 15 have be treated with the silver halide particles 10 as previously shown in FIGS. 2A and 2B. In order for the silver halide particles 10 to work properly, the pad 35 containing the silver halide particles 10 must be permeable to the biological and physiological fluids and the exudates of the wound 20. Preferred polymers for anti-stick barrier layer 50 of the embodiment are polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile. However, the invention is not limited to these polymers and any suitable polymers can be used. A water permeable polymer permits water to move freely through the anti-stick barrier layer 50 allowing the microorganisms 55 to reach as indicated by the arrows 60 and come into contact with the silver halide particles 10. As the exudates containing the microorganisms 55 are absorbed by the pad 35, the microorganisms 55 and the silver halide particles 10 come into close proximity for the growth of the micro-organism 55 to be eliminated or substantially reduced by the silver halide particles 10. In another embodiment, other articles, such as gauze, bandages, cotton swabs and cotton balls, can have fibers 5 treated with the silver halide particles 10. The use of silver halide treated fibers is very advantageous in bandages use for the treatment of burns.

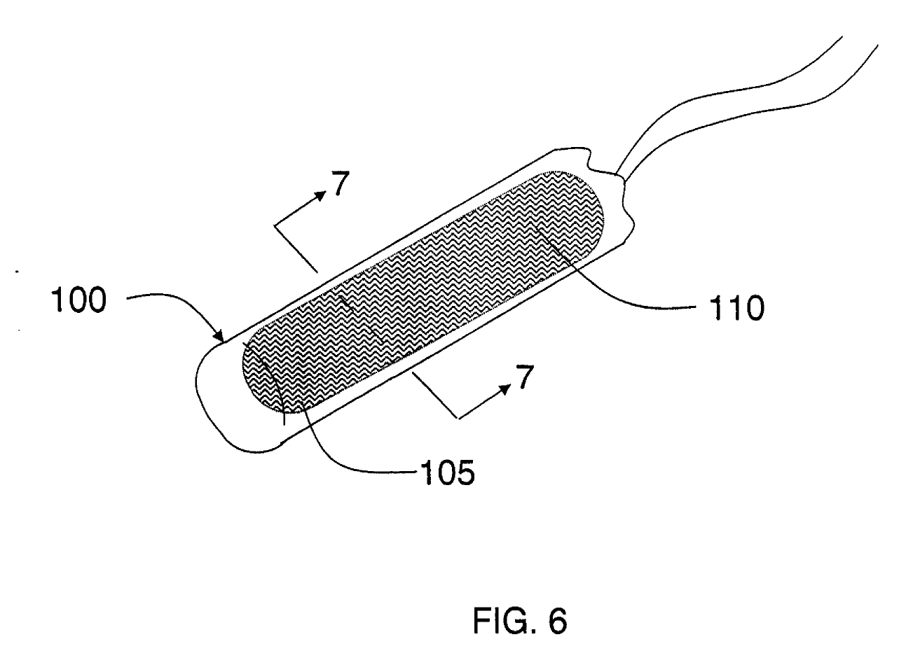

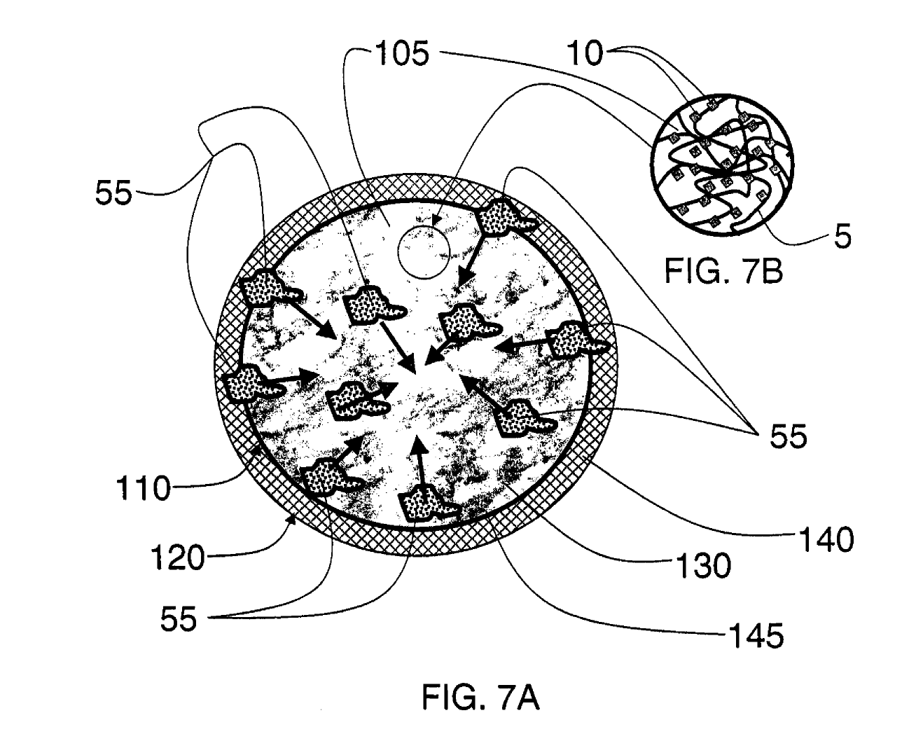

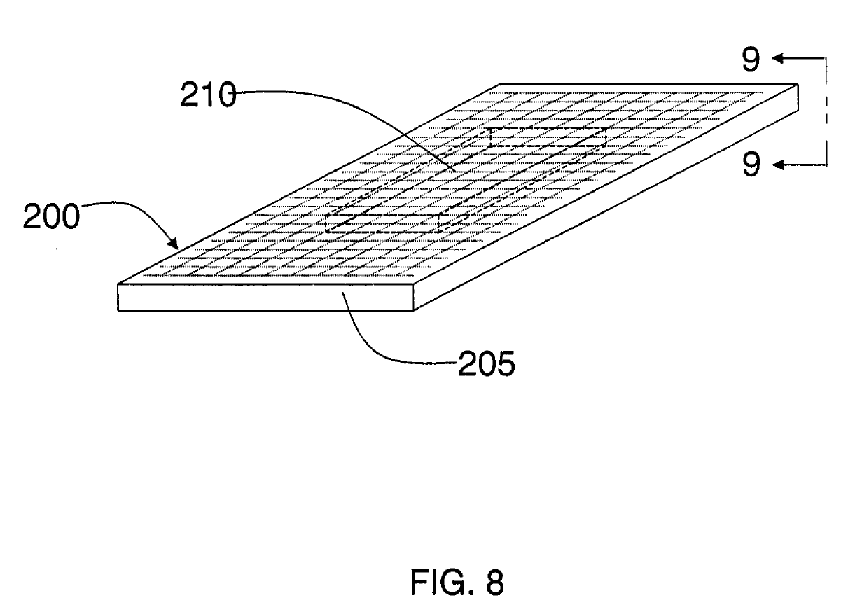

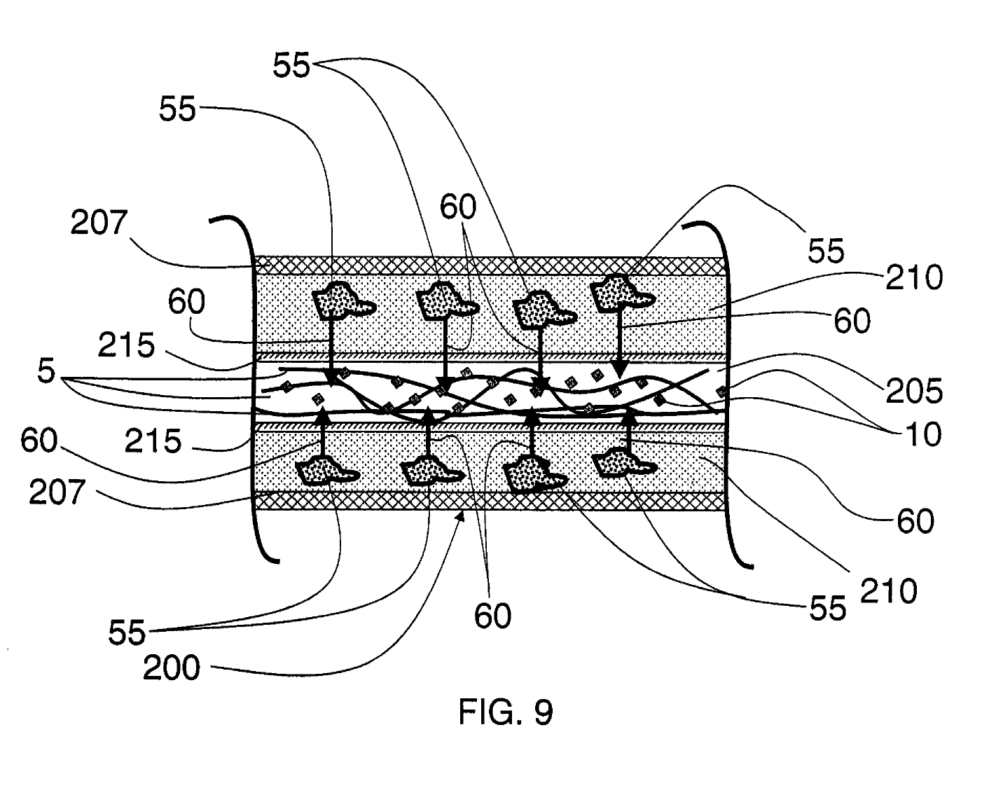

FIGS. 6, 7A, 7B, 8 and 9 illustrate articles that are designed to be placed within a living animal, such as a human. These articles are, for example, fibrous articles intended for absorption of body fluids, such as tampons and similar catamenial devices. As shown in FIGS. 6, 7A, 7B, 8 and 9, a fibrous absorbent article 100 includes fibrous material 105 capable of absorbing body fluids such as catamenial fluids and the like. The fibrous material 105 can be arranged to form a woven or non-woven structure. The fibrous absorbent article 100, in the particular example of FIG. 6, is a tampon which has a well-known cylindrical shape and can consist of a number of fibrous layers and a core 110 as shown in FIGS. 7A and 7B. As another example, a sanitary napkin 200 as shown in FIGS. 8 and 9 can form the absorbent article and can consist of a plurality of fibrous absorption fabrics. FIGS. 6, 7A, 7B, 8 and 9 are discussed in more detail below.

FIGS. 7A and 7B illustrate a cross-sectional view of the fibrous absorbent article 100 as illustrated in FIG. 6. For exemplary purposes, the fibrous absorbent article 100 of FIGS. 7A and 7B will be a tampon 120. The tampon 120 consists of a number of fibrous layers, such as inner layer 130 and outer layer 140. The inner layer 130 is made the fibrous material 105 that includes fibers 5 treated with silver halide particles 10 as shown in the greatly enlarged view of FIG. 7B. A barrier layer 145 surrounds the inner layer 130 and the outer layer 140.

In order for the silver halide particles 10 to work properly, the inner layer 130 containing the silver halide particles 10 must be permeable to water and have the silver halide particles 10 attached to the fibers 5 as previously described. Preferred polymers for the inner 130, outer 140 and barrier 145 layers have been previously described. A water permeable polymer permits water to move freely through the outer and inner layer 130 allowing the silver halide particles 10 to come into contact with the microorganisms 55. The additional barrier 145 can be used to prevent the exudates and microorganism 55 from leaching back out of the tampon 120. Accordingly, the growth of the microorganism 55 is eliminated or substantially reduced preventing infection by using the silver halide particles 10 to significantly reduce or eliminate the amount of microorganisms 55 in the catamenial fluids captured by the tampon 120.

FIGS. 8-9 illustrate a perspective view of a sanitary napkin, generally referred to as 200. The sanitary napkin 200 consists of a number of fibrous layers, such as inner layer 205 and outer layer 210. The inner layer 205 includes fibers 5 treated with silver halide particles 10 as shown in the greatly enlarged view of FIG. 9 and can be surrounded by a barrier layers 215. The barrier layers 215 allow moisture to flow 60 into the layers 205 and 210 but prevent the moisture from flowing back out in the other direction. In order for the silver halide particles 10 to work properly, the inner layer 205 containing the fibers 5 with the silver halide particles 10 must be permeable to water. Preferred polymers for layers 205 and 210 of the invention have been previously described. As the sanitary napkin 200 captures catamenial fluids, the growth of the microorganism 55 is eliminated or severely reduced preventing infection and odor due to the silver halide particles contained in the inner layer 205. Addition liners 207 can be used to prevent fluids from escaping from the layer 210.

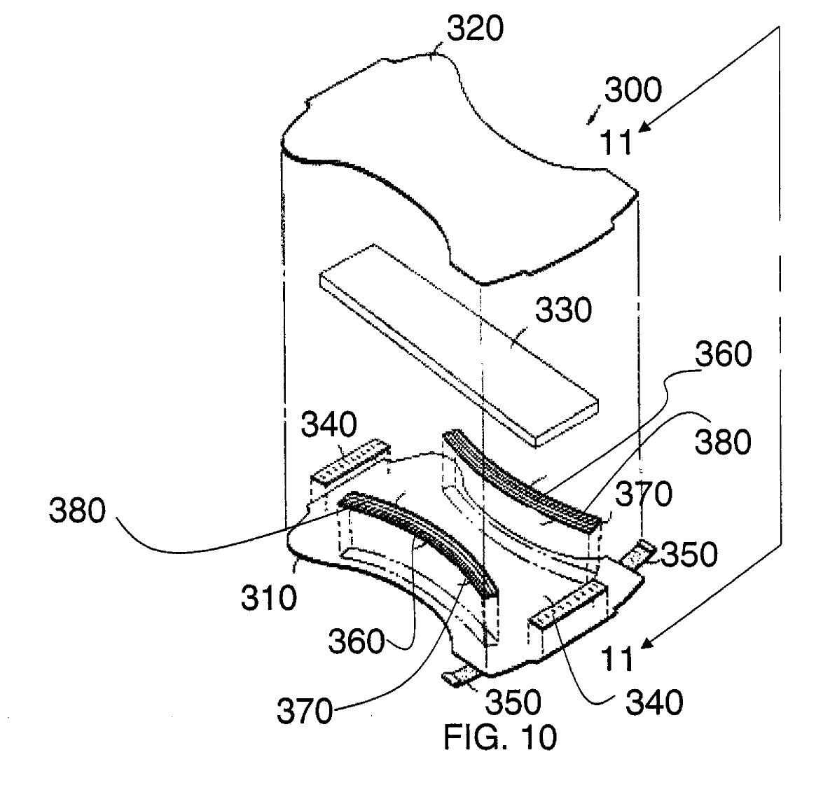

FIG. 10 illustrates a disposable diaper, generally referred to as 300. The diaper 300 includes low-density absorbent fibrous foam composites including a water-insoluble fiber and a superabsorbent material. The superabsorbent material has a weight amount between about 10 to 70 weight percent and the water-insoluble fiber has a weight amount between about 20 to 80 weight percent, wherein weight percent is based on total weight of the absorbent composite.

Referring to FIG. 10, the disposable diaper 300 includes outer cover 310, body-side liner 320, and absorbent core 330 located between body-side liner 320 and outer cover 310. Absorbent core 330 can include any fibrous absorbent structures. Body-side liner 320 and outer cover 310 are constructed of conventional non-absorbent materials. By “non-absorbent,” it is meant that these materials, excluding the pockets filled with superabsorbent, have an absorptive capacity not exceeding 5 grams of 0.9% aqueous sodium chloride solution per gram of material. Attached to outer cover 310 are waist elastics 340, fastening tapes 350 and leg elastics 360. The leg elastics 360 typically have a carrier sheet 370 and individual elastic strands 380.

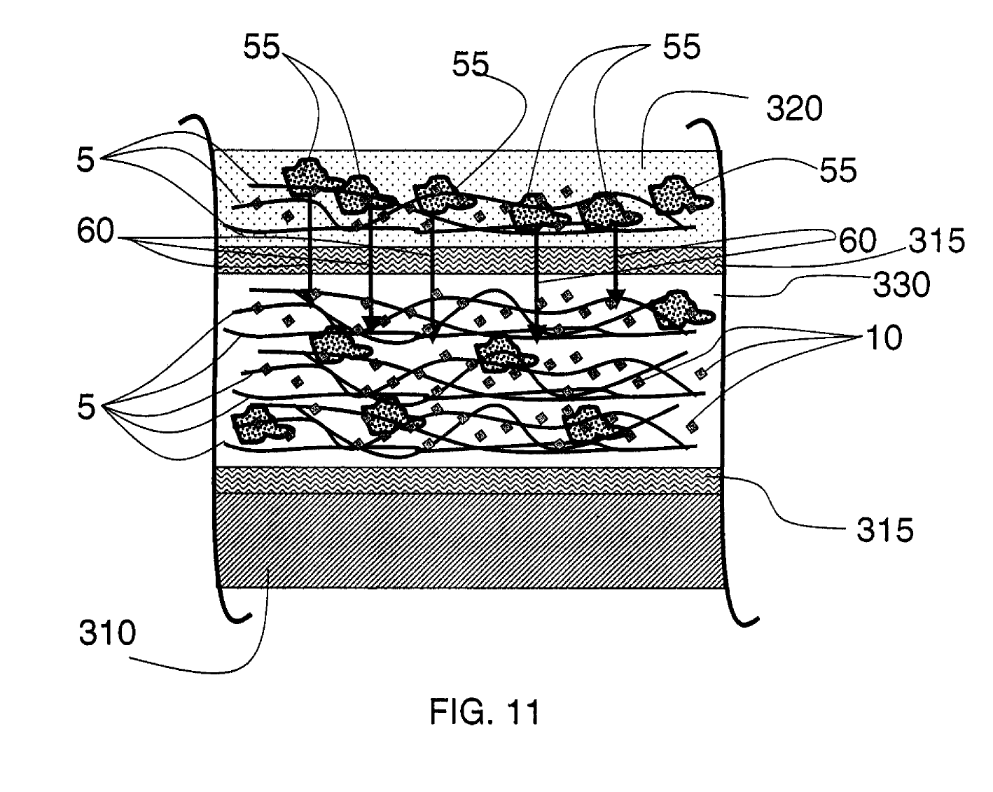

FIG. 11 illustrates an enlarged sectional view of the diaper 300 shown in FIG. 10. The fibers 5 treated with silver halide particles 10 are immobilized in the body-side liner 320 or in the superabsorbent material disposed or incorporated in the diaper's absorbent core 330. The absorbent core 330 is located between body-side liner 320 and outer cover 310 and can be surrounded by a barrier layer 315. In order for the silver halide particles 10 to work properly, the body-side liner 320 and absorbent core 330 containing the fibers 5 with the silver halide particles 10 must be permeable to water as previously described. A water permeable polymer permits water to move freely through the body-side liner 320 and absorbent core 330 allowing the microorganisms 55 to come 60 into close proximity to the silver halide particles 10. By using the sliver halide particles 10 to significantly reduce the amount of microorganisms 55 in the bodily fluids captured by the disposable diaper 300, the growth of the microorganism 55 is eliminated or substantially reduced preventing infection and eliminating odor.

In all the embodiments discussed above, it is preferred that the article is replaced with another identical article after the time in which the effectiveness of the article substantially decreases. The details and specifications of the articles, support structure, derivatized particles, and metal-ion sequestrant are the same as those described above for the article.

The various embodiments described above are provided by way of illustration only and should not be construed to limit the invention. Those skilled in the art will readily recognize various modifications and changes that may be made to the present invention without following the example embodiments and applications illustrated and described herein, and without departing from the true spirit and scope of the present invention, which is set forth in the following claims.

### PARTS LIST

5 fibers
10 silver halide particles
15 bandage
20 wound
25 arm
30 support
35 pad
40 adhesive section
45 skin
50 anti stick layer
55 microorganisms
60 arrow
100 fibrous absorbent article
105 fibrous material
110 central core
120 tampon
130 inner layer
140 outer layer
145 barrier layer
200 sanitary napkin
205 outer layer
210 inner layer
215 barrier layer
300 disposable diaper
310 outer cover
320 body side liner
330 absorbent core
340 waste elastics
350 fastening tapes
360 leg elastics
370 carrier sheet
380 elastic strands

1.-21. (canceled)

22. A method for creating an article having an antimicrobial agent to inhibit the growth of microorganisms in biological, non-biological and physiological fluids, the method comprising:
providing a structure having fibers; and
binding silver halide particles to the fibers using a hydrophilic gelatin polymer composition that is substantially free of organic solvents and that does not solidify or gel at 25° C.

23. The method of claim 22, wherein using the hydrophilic gelatin polymer composition further comprises using a hydrophilic gelatin polymer composition having a weight percentage of the gelatin in the range of 1 to 3%.

24. The method of claim 22 further comprising applying a hydrophobic binder resin to the fibers.

25. The method of claim 24, wherein applying the hydrophobic binder further comprises applying a hydrophobic binder having film-forming properties with a glass transition temperature ranging from about −30 C to about 90 C.

26. The method of claim 24, wherein applying the hydrophobic binder further comprises applying a hydrophobic binder having poly-dispersed particles with sizes ranging from about 10 nm to about 10,000 nm.

27. The method of claim 22 further comprising selecting the silver halide particles from the group consisting of chloride, bromide and iodide.

28. The method of claim 27, wherein the group further comprises selecting combinations of chloride, bromide, and iodide.

29. The method of claim 22 further comprising providing a polymer or polymeric layer containing fibers coated with the silver halide particles.

30.-31. (canceled)

32. The method of claim 22 further comprising providing a barrier layer that is permeable to water.

33. The method of claim 32, wherein providing the barrier layer further comprises providing a barrier layer having a thickness in the range of 0.1 microns to 10.0 microns.

34. The method of claim 32, wherein providing the barrier layer further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

35.-37. (canceled)

38. The method of claim 22 further comprising maintaining the microorganisms in a substantially biostatic state.

39. The method of claim 22 further comprising maintaining the microorganisms to a prescribed level.

40.-41. (canceled)

42. The method of claim 22, wherein providing the structure further comprises providing an article from the group consisting of a bandage, cotton balls, gauze, swab, diapers, tampons, feminine napkins, panty lines, shoe liners, facial tissues, toilet paper, paper towels and sponges.

43. A method for creating an article having an antimicrobial agent to inhibit the growth of microorganisms in biological, non-biological and physiological fluids, the method comprising:
providing a structure having fibers;
binding silver halide particles to the fibers using a hydrophilic gelatin polymer composition that is substantially free of organic solvents and that does not substantially solidify or gel at 25° C.; and
applying a hydrophobic binder resin to the fibers.

44. The method of claim 43, wherein using the hydrophilic gelatin polymer composition further comprises using a hydrophilic gelatin polymer composition having a weight percentage of the gelatin in the range of 1 to 3%.

45. The method of claim 43, wherein applying the hydrophobic binder further comprises applying a hydrophobic binder having film-forming properties with a glass transition temperature ranging from about −30 C to about 90 C.

46. The method of claim 43, wherein applying the hydrophobic binder further comprises applying a hydrophobic binder having poly-dispersed particles with sizes ranging from about 10 nm to about 10,000 nm.

47. The method of claim 43 further comprising selecting the silver halide particles from the group consisting of chloride, bromide and iodide.

48. The method of claim 47, wherein the group further comprises selecting combinations of chloride, bromide, and iodide

49. The method of claim 43 further comprising providing a polymer or polymeric layer containing fibers coated with the silver halide particles.

50.-51. (canceled)

52. The method of claim 43 further comprising providing a barrier layer that is permeable to water.

53. The method of claim 52, wherein providing the barrier layer further comprises providing a barrier layer having a thickness in the range of 0.1 microns to 10.0 microns.

54. The method of claim 52, wherein providing the barrier layer further comprises providing one or more of polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene and polypropylene or polyacrylonitrile.

55.-61. (canceled)

62. The method of claim 43, wherein providing the structure further comprises providing an article from the group consisting of a bandage, cotton balls, gauze, swab, diapers, tampons, feminine napkins, panty lines, shoe liners, facial tissues, toilet paper, paper towels and sponges.
